(19) United States
(12) Patent Application Publication
(10) Pub. No.: US 2024/0393103 A1
(43) Pub. Date: Nov. 28, 2024

(54) PACKAGE DIMENSIONING AT A KIOSK

(71) Applicant: Position Imaging, Inc., Portsmouth, NH (US)

(72) Inventors: Narasimhachary Nallana Chakravarty, Rollinsford, NH (US); Brian Martel, Boulder, CO (US); Drew Anthony Schena, Manchester, NH (US); Bonnie B. Coffin, Dover, NH (US); Estuardo Carpio, Arlington, MA (US)

(21) Appl. No.: 18/674,120

(22) Filed: May 24, 2024

Related U.S. Application Data
(60) Provisional application No. 63/468,818, filed on May 25, 2023.

(51) Int. Cl. G01B 11/24; G01B 11/22; G01G 19/414

(52) U.S. Cl. CPC G01B 11/24; G01B 11/22; G01G 19/4144

(57) ABSTRACT

A system comprises a first surface; a second surface disposed opposite the first surface by a predetermined distance; and a depth-measuring system having at least one optical sensor disposed facing the first and second surfaces, the at least one optical sensor having a field of view covering at least a portion of the second surface, the at least one optical sensor being configured to measure distance to the first surface through the second surface and to measure distance to an object placed on the second surface.

### RELATED APPLICATIONS

This application claims priority to U.S. provisional application No. 63/468,818, filed May 25, 2023 and entitled “Package Dimensioning at a Self-Serve Packaging Kiosk,” the entirety of which is incorporated by reference herein.

### FIELD OF THE INVENTION

The invention relates to systems, methods, and devices, for example, kiosks, for measuring an object's dimensions and/or other features such as weight using depth sensors.

### BACKGROUND

For many businesses, the need to ship packages is essential. Critical to profitability for such businesses, and to customer satisfaction, is the accurate calculation of shipping costs. The size and weight of the package are principal factors in determining shipping costs. Commonly, heavier packages cost more to ship because of the increased handling and fuel costs to the carriers. The dimensions of a package can also affect shipping cost because of the space the package will occupy when transported.

For purposes of establishing costs, shipping businesses typically have kiosks equipped with scales and dimensional scanners for measuring a package's weight and dimensions. Self-service kiosks further improve shipping operations by enabling customers to weigh their own packages, produce package labels, and pay for shipment without involving the carrier's personnel, thereby requiring less time and resources for package handling. The carrier's personnel can hence attend to other matters. These kiosks thus benefit customers and carriers.

### SUMMARY

In one aspect, a system comprises a first surface; a second surface disposed opposite the first surface by a predetermined distance; and a depth-measuring system having at least one optical sensor disposed facing the first and second surfaces. The at least one optical sensor having a field of view covers at least a portion of the second surface, the at least one optical sensor being configured to measure distance to the first surface through the second surface and to measure distance to an object placed on the second surface. The depth-measuring system further includes a processor in communication with the at least one optical sensor to receive the measured distances. The processor is configured to determine dimensions of the object placed on the second surface based on, in part, a difference in the measured distance to the first surface, a known distance of the second surface from the at least one optical sensor, and the measured distance to the object on the second surface.

In another aspect, a system comprises a non-textured surface; and a depth-measuring system having at least one optical sensor disposed at a predetermined distance from the surface. The at least one optical sensor has a field of view covering at least a portion of the surface. The at least one optical sensor is configured to measure depth information where an object appears on the surface and to measure no depth information where the object does not appear on the surface. The depth-measuring system further includes a processor in communication with the at least one optical sensor to receive the measured depth information, the processor being configured to determine dimensions of the object placed on the surface based on, in part, a difference in the known distance of the surface from the at least one optical sensor and the measured depth information to the object on the surface.

In another aspect, a method for determining dimensions of an object using a system having directly opposed first and second surfaces and a depth sensor disposed at a known distance from the second surface with a field of vision covering the second surface comprises the steps of: measuring by the depth sensor distance to the first surface; measuring by the depth sensor distance to an object placed on the second surface; and determining dimensions of the object placed on the second surface based on, in part, a difference in the measured distance to the first surface, the known distance of the second surface from the depth sensor, and the measured distance to the object on the second surface.

In another aspect, a system comprises a surface having an infrared (IR) absorbent coating; and a depth-measuring system having at least one optical sensor disposed at a predetermined distance from the surface, the at least one optical sensor having a field of view covering at least a portion of the surface, the at least one optical sensor being configured to measure depth information where an object appears on the surface and to measure no depth information where the object does not appear on the surface, the depth-measuring system further including a processor in communication with the at least one optical sensor to receive the measured depth information, the processor being configured to determine dimensions of the object placed on the surface based on, in part, a difference in the known distance of the surface from the at least one optical sensor and the measured depth information to the object on the surface.

### BRIEF DESCRIPTION OF THE DRAWINGS

The present invention is illustrated by way of example and is not limited by the accompanying figures, in which like references indicate similar elements. Elements in the figures are illustrated for simplicity and clarity and have not necessarily been drawn to scale.

FIG. 1 is a functional block diagram of an embodiment of a kiosk, in accordance with some embodiments.

FIG. 2 illustrates a dimensioning component of the kiosk of FIG. 1, in accordance with some embodiments.

FIG. 3 illustrates another dimensioning component of the kiosk of FIG. 1, in accordance with some embodiments.

FIG. 4 illustrates an angling of the field of view of a dimensioning unit 102 to enhance a depth difference between two surfaces, in accordance with some embodiments.

FIG. 5 illustrates another dimensioning component of the kiosk of FIG. 1, in accordance with some embodiments.

FIG. 6 is a side view of a weighing platform, in accordance with some embodiments.

FIG. 7 is a top view of the weighing platform of FIG. 6 without an upper surface, in accordance with some embodiments.

FIG. 8 is a view of a change analysis performed by the weighing platform of FIGS. 6 and 7, in accordance with some embodiments.

FIG. 9 is a functional block diagram of an embodiment of a kiosk, in accordance with some embodiments.

FIG. 10 is a functional block diagram of an embodiment of a kiosk, in accordance with some embodiments.

### DETAILED DESCRIPTION

The present invention relates to a system and method for measuring an object's dimensions and, optionally, the weight of the object, using depth sensors. As an illustrative example, the system and method may be embodied in an interactive, self-serve kiosk as described herein.

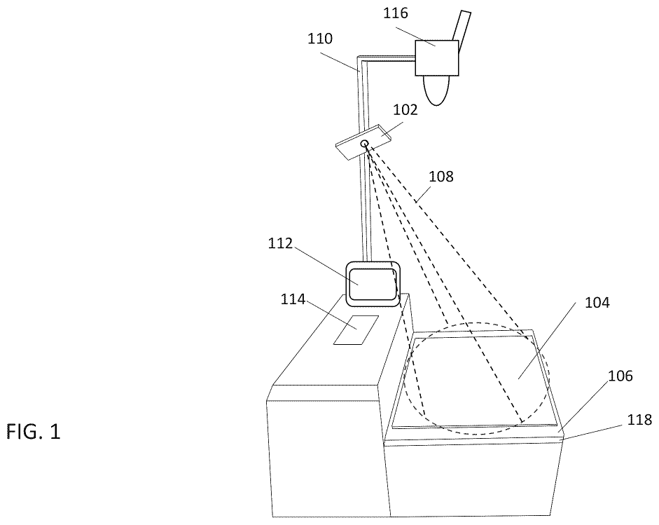

FIG. 1 shows an embodiment of a kiosk 100 including a dimensioning unit 102 and an upper surface 104 disposed above a lower surface 106. Embodiments of the dimensioning unit 102 include, but are not limited to, visible spectrum depth sensors (e.g., color or monochrome cameras), infrared (IR) depth sensors, structured light sensors, and time-of-flight ranging sensors. One or more RGB cameras can send data to a neural net on the processor that computes a depth of an object using monocular images. Time-of-flight ranging sensors include a transmitter that sends out pulsed or continuous light at a particular wavelength, and optical sensors that measure the time it takes to get the signals back. Some embodiments may operate on stereo vision (i.e., multiple cameras) or use a single camera. Stereoscopic sensors have a set of cameras that triangulate depth; some use an IR projector. A field of view 108 of the dimensioning unit 102 covers at least a major portion of the upper surface 104.

The dimensioning unit 102 is attached to post 110 at a given height above the upper surface 104, for example, five feet. This distance is adjustable. After a user adjusts the distance, either by moving the dimensioning unit 102 up or down the post 110, the kiosk 100 performs an autocalibration process to calibrate for the new distance. In an autocalibration process, the system detects the ground plane using the depth measurements and adjusts the height at which the sensor is placed and adjusts the area where an object can be placed for dimensioning based on this height. In FIG. 1, the location of the post 110 positions the dimensioning unit 102 to one side of the upper surface 104, rather than directly above the surface 104. This position of the dimensioning unit 102 produces an angled rather than an orthogonal field of view. Having the dimensioning unit 102 at an angle enhances depth change when an object is placed on the upper surface 104. It is to be understood that the post 110 is just an example of a structure for mounting the dimensioning unit 102. Other mounting arrangements to position the dimensioning unit above the upper surface 104, wherein such arrangements are connected to or independent of the kiosk, can be employed without departing from principles of the invention.

In one embodiment, the upper surface 104 is one side of a substrate, for example, a section or block of glass or plexiglass, that is comprised of a visible light or IR pass-through material. The type of material is tailored to the nature of depth sensing performed by the dimensioning unit 102 (e.g., IR, visible light, time of flight), to facilitate the passing of light or the capturing of images through the upper surface 104. The thickness of this material can depend on a variety of factors, for example, the type of material used, the resolution of the depth sensor(s) of the dimensioning unit 102, and the weight of the material. In one embodiment, the thickness is ½ inch (1.27 cm).

In addition, the upper surface 104 may be treated to provide or enhance its desired light-affecting properties. For example, the upper surface 104 can be painted with a coat of black IR transparent paint, to conceal features below the surface 104 while allowing infrared light to pass through. In an alternative embodiment, the upper surface 104 is coated with an IR absorbent material that is designed to eliminate the reflection and pass-through of IR wavelengths.

The upper surface 104 serves as a layer upon which packages are placed, and is held at a distance (e.g., approximately five inches, though this gap is variable) above the lower surface 106. The gap between the surfaces 104, 106 facilitates the measuring of the dimensions of flat and small items placed atop the optically transparent surface 104.

In FIG. 1, the lower surface 106 is a level of the kiosk 110 that supports the upper surface 104. In practice, any solid surface, for example, the floor or ground, can serve as the lower surface 106. The lower surface 106 can comprise a plurality of surfaces without departing from the principles of the invention, as described below.

In another embodiment, the substrate (e.g., plexiglass) can provide both the upper and lower surfaces 104, 106. For example, one side of the substrate, corresponding to the upper surface 104, can be coated with IR transparent paint, the bulk of the substrate comprises pass-through material (or an air gap), and the opposite side of the substrate, corresponding to the lower surface 106, can be painted with depth-measurable coating. In this embodiment, the thickness of the substrate is sufficient for the resolution of the dimensioning unit 102 (i.e., to provide a measurable distance between the lower surface and the object on the upper surface).

In general, the dimensioning unit 102 facilitates the dimensioning of an object by measuring distance to the object when it is placed on the upper surface 104. Where the object does not appear on the upper surface 104, the visible or IR pass-through material of the surface 104 returns depth information related to the lower surface 106 beneath the upper surface 104. Where the object appears in its field of view, the dimensioning optical unit 102 produces depth measurements corresponding to where the object appears. Accordingly, depth measurements corresponding to where the object appears in the field of view of the dimensioning unit 102 differ from those depth measurements where the object does not appear. From these differences in depth measurements, the kiosk 100 has a computing system (or controller), not shown, that can determine the three-dimensional shape of the object and the dimensions of that object, as described in more detail below. Alternatively, the dimensioning unit 102 has a processor configured (with program code and algorithms) to calculate the object's dimensions from the depth measurements.

In the alternative embodiment (wherein the upper surface 104 is coated with an IR absorbent material), wherever the object does not appear on the upper surface 104, the IR absorbent material of the surface 104 returns no depth information, and wherever the object appears, the dimensioning unit 102 produces depth measurements. Based on the difference between these depth measurements and the known distance of the upper surface 104 from the dimensioning unit 102, the kiosk 100 can determine the three-dimensional shape of the object and the dimensions of that object.

The kiosk 100 can have any one or more of the following optional features, including a display screen 112, a scanner 114, a computer-vision-based object tracking module 116, and a weighing scale 118, each of which are in communication with the kiosk's computing system.

The display screen 112 is a computer screen (e.g., touchscreen) that enables a user to interact with the kiosk 100, for purposes of, for example, receiving instructions on how to use the kiosk, requesting services, and accessing information, for example, about an item placed on the upper surface 104, including its product description, labeling information (such as addressor and addressee), dimensions and weight.

The scanner 114 is an electronic device that optically reads information from a label, barcode, QR code, and the like, affixed to, adjacent to, or otherwise associated with the object being placed on the upper surface 104. The scanner may use optical character recognition (OCR) technology to read the information. The scanner 114 transfers information acquired from the label or code to the computer system.

The computer-vision-based object tracking module 116 is a computer-vision system connected to and controlling a guidance system. The module 116 is configured to register (i.e., associate acquired label information with an object and its location) and track objects within the module's field of view and, additionally or alternatively, guide users to specific objects using light, audio, or both. The computer-vision system includes an image sensor, a depth sensor, or both, connected to a data processing unit (which may be part of the kiosk's computer system) capable of executing image-processing algorithms. The guidance system contains a directional light source and a mechanical and/or electrical system for the operation and orienting of the directional light source or audio system. Examples of such modules, their components and operation, are described in U.S. Pat. No. 11,089,232, titled, “Computer Vision Tracking and Guidance Module”, issued Aug. 10, 2021, the entirety of which patent is incorporated by reference herein.

The weighing scale 118 is configured to measure the weight of an object placed on the upper surface 104, which sits atop the weighing scale 118, as subsequently described in more detail. The lower surface 106 may be part of the weighing scale 118.

During operation of one embodiment of the kiosk, a user passes an object, for example, a package, over the scanner 114, which reads the label information, and then places the package on the upper surface 104. The dimensioning sensor unit 102 determines the dimensions of the object, while the weighing scale 118 measures its weight. The computer-vision-based object tracking module 116 detects the object and associates the label information with it. This object detection may be used to supplement the dimensions determined by the dimensioning sensor unit 102. The tracking module 116 not only acquires the placed object's location but also determines an approximate size of the object that was placed on the shelf. This approximation of the package's dimensions is coarse, but precise enough to affirm, by comparison, that the dimensions measured by the dimensioning unit 102 are in the ballpark. Widely divergent dimensions, as measured by the tracking module 116 and the dimensioning unit 102, would serve to question the accuracy of the dimensioning unit's values.

Further, optionally, the tracking module 116 can employ a neural network, trained to identify commonly used or standard package types, to detect the type of package, and from that information, look up the dimensions related to that package type. For example, if an Access Point uses UPS-provided packaging, the neural network would be trained on the catalogue of such packaging and would know exactly which type of package was placed. Knowing which package type gives the dimensions.

Further, the detection of weight may be used to confirm the presence of an object on the upper surface 104 and thus be used to affirm any depth measurements obtained by the system. Conversely, the detection of depth measurements can be used to affirm any weight measured by the weighing scale 118. In other words, the measure of weight without any depth measurements or the measure of depth without and detection of weight can indicate unreliable data.

As described herein, the tracking system can track an object throughout its journey from one place to another. Here, a chain of custody operation can be performed where the tracking system identifies that an object such as a package is positioned at the dimensioner, and then it tracks the package as it moves from the dimensioner to the shelf and records where it was placed on a shelf or other location. From a three dimensional standpoint, this assures that the object X on the dimensioner has been moved to a location Z on a shelf Y by performing computer vision tracking.

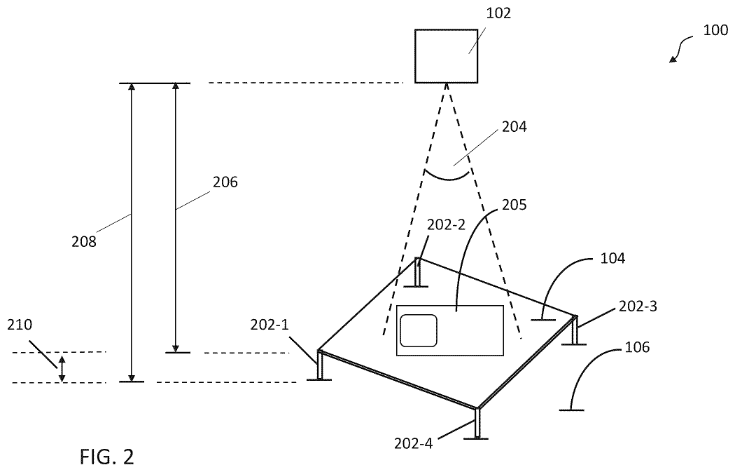

FIG. 2 shows the dimensioning component of a kiosk system 100, wherein a package 205 sits atop the upper surface 104, within the field of view 204 of the dimensioning unit 102. In this illustration, the dimensioning unit 102 is positioned directly above the upper surface 104, and the field of view 204 falls orthogonally onto the package 200. Spacers 202-1, 202-2, 202-3 and 202-4 (generally, spacer 202) separate the upper surface 104 from the lower surface 106. Arrow 206 represents the distance from the dimensioning unit 102 to the upper surface 104, and arrow 208 represents the distance from the dimensioning unit 102 to the lower surface 106. To achieve accurate results, the difference 210 between the two distances 206, 208 must be greater than the depth-differentiating threshold of the dimensioning unit 102.

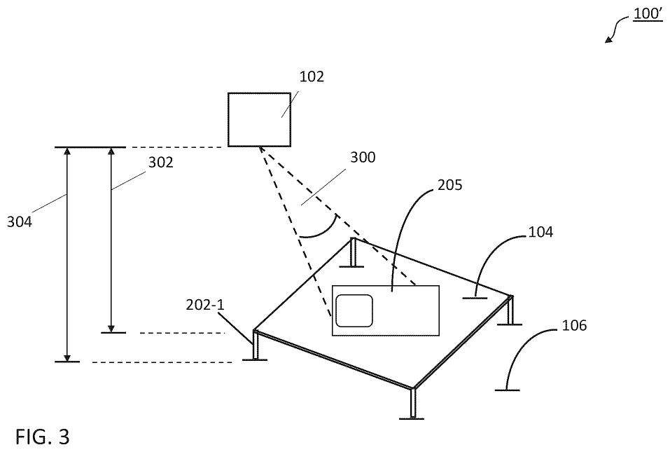

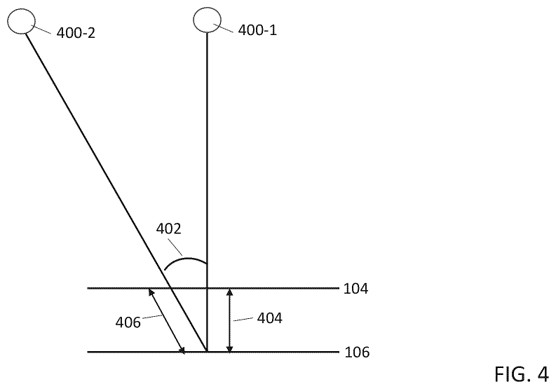

FIG. 3 shows the dimensioning component of a kiosk 100′, similar to the kiosk 100 shown in FIG. 2, with a difference being that the dimensioning unit 102 is positioned to one side of the upper surface 104, which produces an angled field of view 300 that encompasses the package 200. This location of the dimensioning unit 102 enhances the depth differences between the upper and lower surfaces 104, 106, as described more in detail in connection with FIG. 4. In addition, the angled location permits the dimensioning unit 102 to be closer to the upper surface 104 than at an orthogonal location, which might be a factor when placing the kiosk at its operational site. The height 302 of the dimensioning unit 102 above the plane of the upper surface 104 is lower than that shown in FIG. 2. Arrow 302 represents the distance from the dimensioning unit 102 to the upper surface 104, and arrow 304 represents the distance from the dimensioning unit 102 to the lower surface 106. Both distances 302, 304 are shorter than their respective distances 206, 208 in FIG. 2.

FIG. 4 shows how angling the field of view of the dimensioning unit 102 enhances the depth differences between the upper and lower surfaces 104, 106. Camera position 400-1 illustrates an orthogonal location of the dimensioning unit 102, and camera position 400-2 illustrates an angled location of the dimensioning sensor unit 102. Both positions 400-1, 400-2 are at the same height relative to the plane of the optically transparent surface 104. Angle 402 represents the angular difference between the alignments of the camera positions 400-1, 400-2. The gap or distance between the upper and lower surfaces 104, 106 are the same for both camera positions 400-1, 400-2. In addition, having the camera position 400-2 off to the side brings another benefit, that of enlarging the field of view, thus providing opportunities to measure larger objects than if at camera position 400-1, and of enabling the depth sensor to see more sides of the package, thus making more accurate measurements of the dimensions than if only a single side were in view (e.g., from camera position 400-1). The angle 402 produces a larger distance for light to travel across this gap from the camera position 400-2 (ref. no. 406) than from the camera position 400-1 (ref no. 404). The increase in travel distance depends upon the size of the angle 402. For example, an angle 402 of 25 degrees increases the travel distance 406 across the gap from the camera position 400-2 to 1.1 times (1.1×) that of the travel distance 404 across the gap from the camera position 400-1. This relationship of angle to travel distance enables the shortening of the separation between the surfaces 104, 106 without detrimentally affecting the performance of the dimensioning unit 102 to measure depth differences between an object on the upper surface 104 and the lower surface 106.

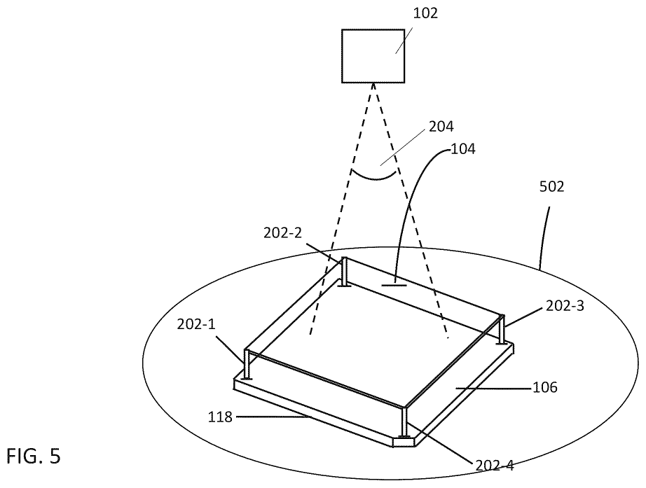

FIG. 5 shows the dimensioning component of the kiosk 100, as shown in FIG. 2, with a difference being inclusion of a weighing platform 502 wherein the lower surface 106 serves as the top surface of the weighing scale 118 of FIG. 1. Spacers 200 separate the upper surface 104 from the lower surface 106 and press against the weighing scale 118. The weight of objects placed on the upper surface 104 thus transfers to the weighing scale 118.

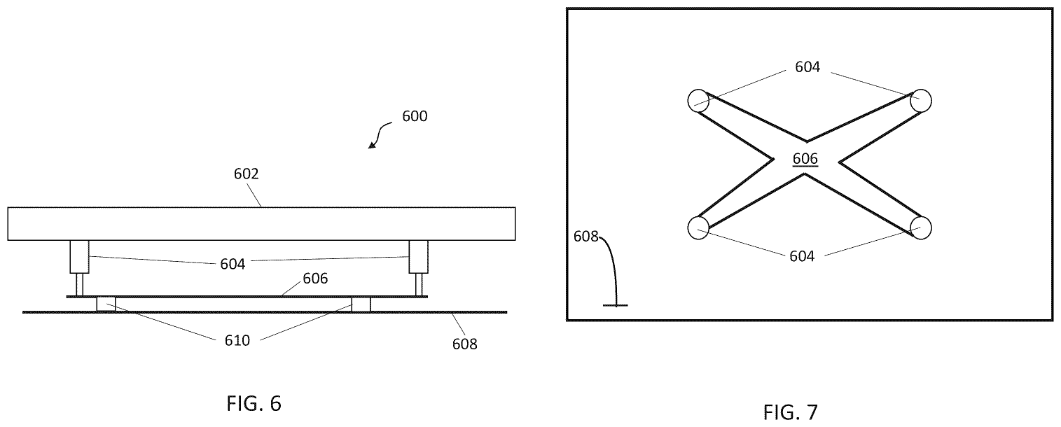

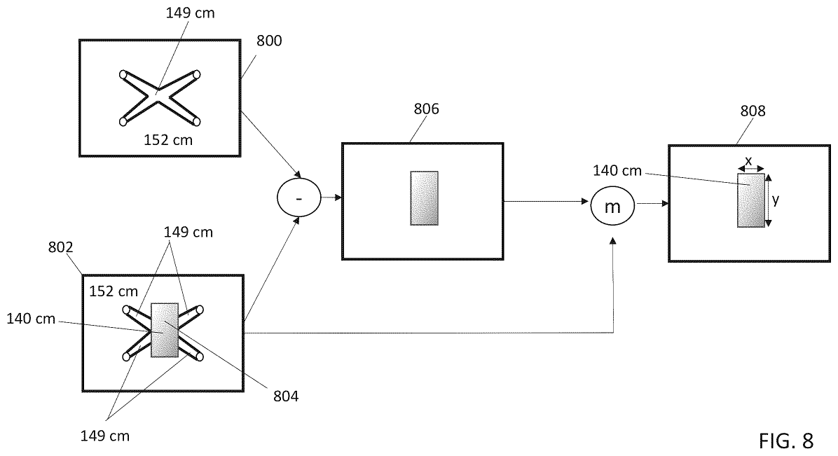

FIG. 6, FIG. 7, and FIG. 8 relate to another embodiment of the weighing platform 502 (FIG. 5) in which the weighing scale is star-shaped and sits upon a base. This embodiment illustrates that the surface beneath the upper surface 104 does not need to be flat (i.e., of uniform distance from the dimensioning unit 102) to practice the principles of the invention.

FIG. 6 shows a side view of a weighing platform 600, including an upper surface 602 of a substrate (e.g., plexiglass) disposed atop spacers 604. The spacers 604 sit atop a weighing scale 606. The weighing scale 606 sits on posts 610, which are on a base 608.

FIG. 7 shows a top view of the weighing platform 600 without the upper surface 602. The weighing scale 606 is star-shaped with four arms and the spacers 604 are disposed at the ends of the arms. The base 608 encompasses the weighing scale 606. The surface level of the base 608 is below a top surface level of the weighing scale 606.

For FIG. 8, consider the following example distances of the weighing platform 600 (each distance is measured with respect to the dimensioning unit 102 of FIG. 1). The distance to the upper surface (or measuring surface) 602 is 145 cm. This distance is not observed by the dimensioning unit 102. The system is initially configured with this distance for subsequent dimensioning of an object on the upper surface. The distance to the surface of the star-shaped weighing scale is 149 cm, and the distance to the surface of the base is 152 cm. During calibration, without any object on the measuring surface 602, the dimensioning unit 102 acquires these depth values for the various surfaces below the measuring surface 104 (e.g., in a depth image captured by the dimensioning unit 102).

In furtherance of this example, consider the distance of an object placed on the measuring surface 602 to be 140 cm. The surface at the top of the weighing scale 606 and the surface of the base 608 upon which the scale sits are far enough from the top of the measuring surface 602 to differentiate with depth data from the object sitting on the measuring surface 602. In contrast, the distance to the top surface of each spacer 604, which abuts the underside of the measuring surface 602, may not be far enough from the top of the measuring surface (depending on the thickness of the substrate, for example, plexiglass) to differentiate in the depth values from an object sitting on the measuring surface. Notwithstanding, these spacer surfaces constitute a small area surrounded by a larger area that is the surface 608, which lies at a distance from the dimensioning unit 102 that exceeds the depth-differentiating threshold. Though calibration may find that the measured depth of the top spacer surface differs from that of the surrounding lower surface 608, post-image processing algorithms during the change analysis can filter or smooth out the small aberration brought about by the spacer.

Calibration of the weighing platform 600 without an object produces a depth image 800, referred to as the background image 800. Depth image or foreground image 802 is captured after an object 804 is placed on the measuring surface 602. It is to be understood, these depth images 800, 802 correspond to the example distances previously mentioned. The dimensioning unit 102 does not measure a distance to the measuring surface 602 because this surface is optically transparent (i.e., light passes through it) or IR absorbent, depending on the embodiment.

A change analysis is performed on the background and foreground images 800, 802, resulting in a change image 806, wherein pixels having greater than a 5 cm difference are highlighted bits, and all other bits are set to zero. In this example, 5 cm is the employed threshold because this depth differential accounts for the depth-discriminating threshold of the dimensioning unit 102. Changes in depth that are less than this depth differential may be attributable to noise because of environmental conditions. Depth changes that are equal to or greater than the depth differential can be relied upon as an object appearing on the upper surface 602. A dimensioning unit 102 with a better accuracy and low variance can allow for smaller threshold values than 5 cm, for example, 2.5 cm. The change image 806 corresponds to the region of interest in the foreground image; it identifies the locale where something has significantly changed.

To acquire the raw depth values, which are used for determining the dimensions of the object 804, the foreground image 802 is then masked by the change image 806. The masking produces an image 808 containing these raw depth values at known pixel locations. From this image 808, the x and y dimensions of the object can be measured (e.g., based on pixel count and the number of pixels per cm). The z dimension is determined by calculating the difference between the raw depth values of the masked pixels and the known distance to the measuring surface 602.

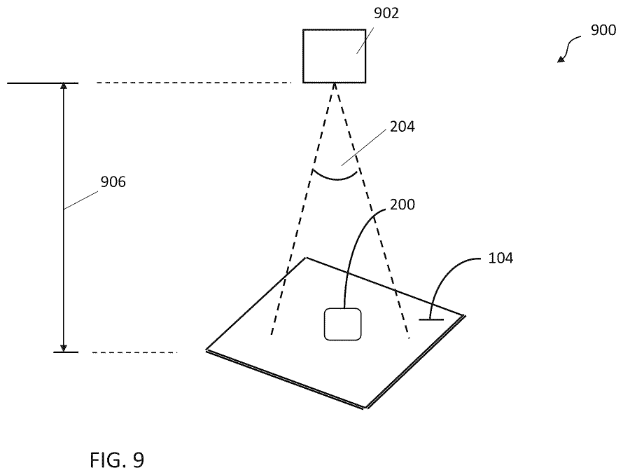

FIG. 9 is a functional block diagram of an embodiment of a kiosk 900, in accordance with some embodiments. The kiosk 900 is similar to the kiosk 200 of FIG. 2 except for the absence of two surfaces 104, 106 separated by a plurality of spacers 202. Instead, only the distance from the dimensioning unit 202 to the single surface 104 is determined, as represented by arrow 906. This can be achieved by a depth sensor 902 above the single surface on which the package 200 is positioned to measure the X, Y, and Z dimensions of the package 200. The depth estimation is inherent to the depth sensor 902. This configuration eliminates the need for the posts or spacers 202 that would otherwise hold the depth sensor 902 high enough to gather the dimension data with a single sensor.

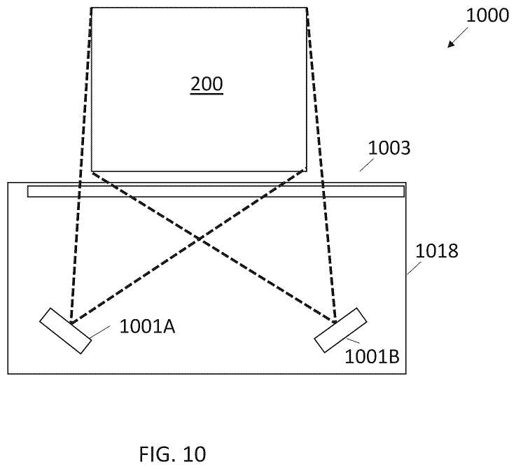

FIG. 10 is a functional block diagram of an embodiment of a kiosk 1000, in accordance with some embodiments.

The kiosk 1000 includes a weighing scale 1018 similar to a weighing scale of FIGS. 5-7, except constructed to incorporate two or more depth sensors 1001A, 1001B (generally, 1001) at an interior of the weighing scale 1018. The kiosk 1000 does not have a depth sensor above the surface as in FIG. 9. However, instead of a dimensioning sensor unit, two or more depth sensors 1001A, 1001B (generally, 1001) determine the dimensions of an object such as a package, while the weighing scale 1018 measures its weight. Although two depths sensors are shown, the weighing station may accommodate up to four depth sensors 1001, or more. The depth sensors 1001A, 1001B performing the dimension measurements are positioned below the platform, for example, embedded under the platform such as a housing of the weighing scale 1018 that is sufficiently large enough to accommodate the sensors. This arrangement allows the sensors 1001 to each gather X, Y, and Z data, which can eliminate the need for posts or spacers, e.g., shown in FIGS. 2-6. More specifically, the depth sensors under the platform are able to see past the surface, which is formed of an IR transparent material 1003. The platform is made wider so that the sensors 1001 are able to perceive from the side angle as seen in FIG. 10. Although two depth sensors 1001A, 1001B, additional sensors can be mounted underneath the object. During operation, data from each sensor is gathered and sent to the processing unit (not shown) which computes the overall dimensions of the object. The sensors 1001 can be IR stereoscopic depth sensors or lidar sensors that operate in the IR spectrum, which would be paired with the IR transparent platform 1003, or the sensors 1001 could be mono color RGB, which would need a visible spectrum transparent platform such as glass.

In some applications, when dimensioning an item requires the user to print and attach a label, the system will include capabilities to detect this behavior and seamlessly integrate label scanning and verification processes using various sensor embodiments. Upon initiating the dimensioning process, the system prompts the user to print and attach a label to the object. The system's sensors, including cameras or other suitable technologies, detect the presence of the label on the object. If a barcode is present on the label, the system automatically scans the barcode using integrated scanning capabilities. The system can also utilize OCR technology to read and verify the information on the label, confirming its accuracy and relevance to the dimensioning process. The system can also provide real-time feedback to the user regarding the successful scanning and verification of the label, ensuring proper documentation and labeling of the object during the dimensioning process.

Upon completion of dimensioning, the system may initiate item tracking to monitor the object's transition from the dimensioning area to a staging area. It will utilize real-time tracking data to monitor and record the object's location as it moves through designated areas. The tracking can be performed as mentioned here (a link to our previous tracking patents) or can be as simple as another tracking algorithm following the object from the dimensioning area to the staging area. Automatically assign or update the object's status and location within the tracking system as it reaches the designated staging area (e.g., shelf, bin).

As will be appreciated by one skilled in the art, aspects of the present invention may be embodied as a system, method, and apparatus. Thus, some aspects of the present invention may be embodied entirely in hardware, entirely in software (including, but not limited to, firmware, program code, resident software, microcode), or in a combination of hardware and software.

Having described above several aspects of at least one embodiment, it is to be appreciated that various alterations, modifications, and improvements will readily occur to those skilled in the art. Such alterations, modifications, and improvements are intended to be part of this disclosure and are intended to be within the scope of the invention. Embodiments of the methods and apparatuses discussed herein are not limited in application to the details of construction and the arrangement of components set forth in the foregoing description or illustrated in the accompanying drawings. The methods and apparatuses are capable of implementation in other embodiments and of being practiced or of being carried out in various ways. Examples of specific implementations are provided herein for illustrative purposes only and are not intended to be limiting. References to “one embodiment” or “an embodiment” or “another embodiment” means that a feature, structure, or characteristic described in connection with the embodiment is included in at least one embodiment described herein. References to one embodiment within the specification do not necessarily all refer to the same embodiment. The features illustrated or described in connection with one exemplary embodiment may be combined with the features of other embodiments.

Also, the phraseology and terminology used herein is for the purpose of description and should not be regarded as limiting. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all the described terms. Any references to front and back, left and right, top and bottom, upper and lower, inner, and outer, interior, and exterior, and vertical and horizontal are intended for convenience of description, not to limit the described systems and methods or their components to any one positional or spatial orientation. Accordingly, the foregoing description and drawings are by way of example only, and the scope of the invention should be determined from proper construction of the appended claims, and their equivalents.

As will be appreciated by one skilled in the art, aspects of the present invention may be embodied as a system, method, and apparatus. Thus, some aspects of the present invention may be embodied entirely in hardware, entirely in software (including, but not limited to, firmware, program code, resident software, microcode), or in a combination of hardware and software.

Having described above several aspects of at least one embodiment, it is to be appreciated that various alterations, modifications, and improvements will readily occur to those skilled in the art. Such alterations, modifications, and improvements are intended to be part of this disclosure and are intended to be within the scope of the invention. Embodiments of the methods and apparatuses discussed herein are not limited in application to the details of construction and the arrangement of components set forth in the foregoing description or illustrated in the accompanying drawings. The methods and apparatuses are capable of implementation in other embodiments and of being practiced or of being carried out in various ways. Examples of specific implementations are provided herein for illustrative purposes only and are not intended to be limiting. References to “one embodiment” or “an embodiment” or “another embodiment” means that a feature, structure or characteristic described in connection with the embodiment is included in at least one embodiment described herein. References to one embodiment within the specification do not necessarily all refer to the same embodiment. The features illustrated or described in connection with one exemplary embodiment may be combined with the features of other embodiments.

Also, the phraseology and terminology used herein is for the purpose of description and should not be regarded as limiting. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all the described terms. Any references to front and back, left and right, top and bottom, upper and lower, and vertical and horizontal, and the like are intended for convenience of description, not to limit the present systems and methods or their components to any one positional or spatial orientation. Accordingly, the foregoing description and drawings are by way of example only, and the scope of the invention should be determined from proper construction of the appended claims, and their equivalents.

What is claimed is:

1. A system comprising:
a first surface;
a second surface disposed opposite the first surface by a predetermined distance;
a depth-measuring system having at least one optical sensor disposed facing the first and second surfaces, the at least one optical sensor having a field of view covering at least a portion of the second surface, the at least one optical sensor being configured to measure distance to the first surface through the second surface and to measure distance to an object placed on the second surface, the depth-measuring system further including a processor in communication with the at least one optical sensor to receive the measured distances, the processor being configured to determine dimensions of the object placed on the second surface based on, in part, a difference in the measured distance to the first surface, a known distance of the second surface from the at least one optical sensor, and the measured distance to the object on the second surface.

2. The system of claim 1, further comprising a weighing scale, and wherein the second surface sits atop the weighing scale to measure weight of the object placed on the second surface.

3. The system of claim 1, wherein the second surface has an infrared (IR) transparent coating.

4. The system of claim 1, wherein the at least one optical sensor is any one or more of a visible spectrum color or monochrome depth sensor, infrared (IR) depth sensor, stereoscopic sensor, structured light sensor, or time-of-flight ranging sensor.

5. The system of claim 1, wherein the second surface is made of an IR transparent material.

6. The system of claim 5, wherein the IR transparent material of the second surface is one of glass and plexiglass.

7. A system comprising:
a non-textured surface; and
a depth-measuring system having at least one optical sensor disposed at a predetermined distance from the surface, the at least one optical sensor having a field of view covering at least a portion of the surface, the at least one optical sensor being configured to measure depth information where an object appears on the surface and to measure no depth information where the object does not appear on the surface, the depth-measuring system further including a processor in communication with the at least one optical sensor to receive the measured depth information, the processor being configured to determine dimensions of the object placed on the surface based on, in part, a difference in the known distance of the surface from the at least one optical sensor and the measured depth information to the object on the surface.

8. The system of claim 7, further comprising a weighing scale, and wherein the surface sits atop the weighing scale to measure weight of the object placed on the second surface.

9. The system of claim 7, wherein the at least one optical sensor is any one or more of a visible spectrum color or monochrome depth sensor, infrared (IR) depth sensor, stereoscopic sensor, structured light sensor, or time-of-flight ranging sensor.

10. The system of claim 7, wherein the at least one optical sensor is one of stereo IR, grayscale, or RGB.

11. The system of claim 7, wherein the at least one optical sensor is stereo IR with its IR laser projection pattern turned off.

12. A system comprising:
a surface having an infrared (IR) absorbent coating; and
a depth-measuring system having at least one optical sensor disposed at a predetermined distance from the surface, the at least one optical sensor having a field of view covering at least a portion of the surface, the at least one optical sensor being configured to measure depth information where an object appears on the surface and to measure no depth information where the object does not appear on the surface, the depth-measuring system further including a processor in communication with the at least one optical sensor to receive the measured depth
